(19) United States
(12) Patent Application Publication
(10) Pub. No.: US 2021/0329741 A1
(43) Pub. Date: Oct. 21, 2021

(54) WATER HEATER APPLIANCES AND METHODS FOR DELAYED ACTIVATION

(71) Applicant: Haier US Appliance Solutions, Inc., Wilmington, DE (US)

(72) Inventors: Paul Goodjohn, Crestwood, KY (US); Andrew L. Reder, Louisville, KY (US)

(21) Appl. No.: 16/849,024

(22) Filed: Apr. 15, 2020

(51) Int. Cl. H05B 1/02; F24D 19/10; F24H 1/18; G06F 1/30; G05B 19/042

(52) U.S. Cl. CPC H05B 1/0252; F24D 19/1051; G05B 2219/2658; G06F 1/30; G05B 19/042; F24H 1/185

(57) ABSTRACT

A water heater appliance, as provided herein, may include a casing, a tank, an inlet conduit, an electric heating system, and a controller. The tank may be disposed within the casing, the tank defining an inlet and an outlet. The inlet conduit may be mounted to the tank at the inlet of the tank. The electric heating system may be in thermal communication with the tank to heat water within the tank. The controller may be in operative communication with the electric heating system. The controller may be configured to initiate a responsive-heating cycle. The responsive heating cycle may include detecting expiration of a dormant event at the water heater appliance, initiating a randomized delay period in response to detecting expiration of the dormant event, and initiating activation of the water heater appliance following the delay period.

### FIELD OF THE INVENTION

The present subject matter relates generally to water heater appliances, and more particularly to methods or water heater appliances having one or more features for delayed activation thereof.

### BACKGROUND OF THE INVENTION

Water heater appliances (i.e., water heaters) are used for storing or supplying hot water to residential and commercial properties. A typical residential water heater holds about fifty gallons of water inside a steel reservoir tank. Other residential water heaters are known as “constant flow” water heaters and include a relatively small tank or heat-exchange pipe in which water is heated as it flows through the water heater. Many water heaters permit a consumer to set the thermostat to a temperature between 90 and 150 degrees Fahrenheit (F) (32 to 65 degrees Celsius (C)). To prevent scalding and to save energy, consumers may set the thermostat to heat the reservoir water to a temperature in a range between 120 degrees F. to 140 degrees F. (about 49 degrees C. to 60 degrees C.).

Water heating may constitute a significant portion (e.g., 10 to 15%) of household energy usage. Thus, water heaters can be a significant drain on a local utility. This is especially notable during instances in which many water heaters turn on at the same time to create a surge in energy demands for a utility or residential power grid. Such surges may be common after a large-scale unplanned power outage (e.g., a blackout) or planned power restriction (e.g., a brownout or Sabbath period for religiously-observant communities). Additionally or alternatively, such surges may be common when many water heaters are programmed to activate at the same time (e.g., based on known or variable power rate schedules). For instance, in some locations of the United States and globally, the cost for electrical energy to heat water can depend upon the time of day, day of the week and season of the year. In areas of the United States where energy is at a premium, utility companies often divide their time of use rates into off-peak and on-peak energy demand periods with a significant rate difference between the periods. Off-peak and on-peak periods may be set according to a fixed or variable schedule or may be further dictated by emergency load shedding request signals from a utility.

Accordingly, it would be useful to provide a water heater or method of operation that includes steps or features for mitigating power surges to a utility or residential power grid.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a method of operating a water heater appliance is provided. The method may include detecting expiration of a dormant event at the water heater appliance. The method may further include initiating a randomized delay period in response to detecting expiration of the dormant event. The method may still further include initiating activation of the water heater appliance following the delay period.

In another exemplary aspect of the present disclosure, a water heater appliance is provided. The water heater appliance may include a casing, a tank, an inlet conduit, an electric heating system, and a controller. The tank may be disposed within the casing, the tank defining an inlet and an outlet. The inlet conduit may be mounted to the tank at the inlet of the tank. The electric heating system may be in thermal communication with the tank to heat water within the tank. The controller may be in operative communication with the electric heating system. The controller may be configured to initiate a responsive-heating cycle. The responsive heating cycle may include detecting expiration of a dormant event at the water heater appliance, initiating a randomized delay period in response to detecting expiration of the dormant event, and initiating activation of the water heater appliance following the delay period.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a water heater appliance according to an exemplary embodiment of the present disclosure.

FIG. 2 provides a schematic view of certain components of the exemplary water heater appliance of FIG. 1.

FIG. 3 provides a flow chart illustrating a method of operating a water heater appliance according to exemplary embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components.

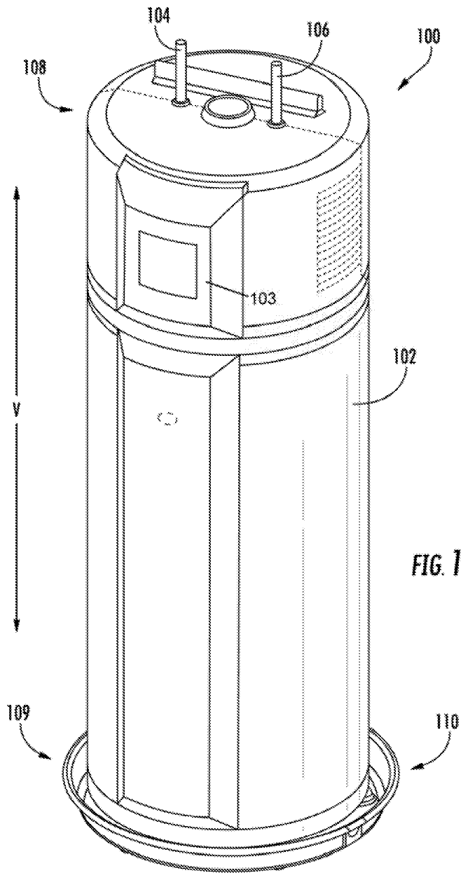

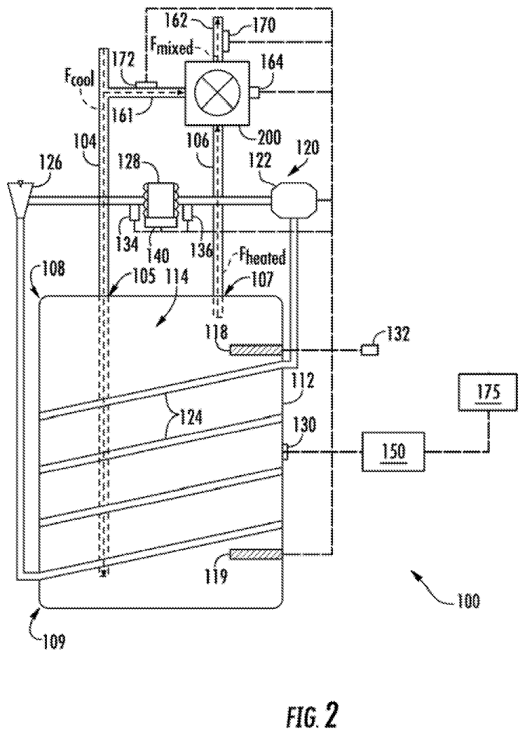

FIG. 1 provides a perspective view of a water heater appliance 100 according to an exemplary embodiment of the present disclosure. FIG. 2 provides a schematic view of certain components of water heater appliance 100 within a heating assembly 10. As may be seen in FIGS. 1 and 2, water heater appliance 100 includes a casing 102 and a tank 112 mounted within casing 102. Tank 112 defines an interior volume 114 for heating water therein.

Water heater appliance 100 also includes an inlet conduit 104 and an outlet conduit 106 that are both in fluid communication with tank 112 within casing 102. As an example, cold water from a water source (e.g., a municipal water supply or a well) enters water heater appliance 100 through inlet conduit 104. From inlet conduit 104, such cold water enters interior volume 114 of tank 112, wherein the water is heated to generate heated water. Such heated water exits water heater appliance 100 at outlet conduit 106 and, for example, is supplied to a bath, shower, sink, or any other suitable feature.

As may be seen in FIG. 1, water heater appliance 100 extends between a top portion 108 and a bottom portion 109 along a vertical direction V. Thus, water heater appliance 100 is generally vertically oriented. Water heater appliance 100 can be leveled (e.g., such that casing 102 is plumb in the vertical direction V) in order to facilitate proper operation of water heater appliance 100.

In certain embodiments, water heater appliance 100 includes a control panel 103 having one or more user inputs (e.g., attached to casing 102 proximal to top portion 108). Control panel 103 may be in communication with a controller 150 (FIG. 2), as would be understood. Control panel 103 may thus receive power as directed by controller 150. Additionally or alternatively, a user of water heater appliance 100 may interact with the user inputs of control panel 103 to operate the water heater appliance 100, and user commands may be transmitted between the user inputs and controller 150 to facilitate operation of the water heater appliance 100 based on such user commands. A display may additionally be provided in the control panel 103 in communication with the controller 150. The display may, for example be a touchscreen or other text-readable display screen, or alternatively may simply be a light that can be activated and deactivated as required to provide an indication of, for example, an event or setting for water heater appliance 100.

In some embodiments, a drain pan 110 is positioned at bottom portion 109 of water heater appliance 100 such that water heater appliance 100 sits on drain pan 110. Drain pan 110 sits beneath water heater appliance 100 along the vertical direction V (e.g., to collect water that leaks from water heater appliance 100 or water that condenses on an evaporator 128 of water heater appliance 100).

It should be understood that water heater appliance 100 is provided by way of example only and that the present disclosure may be used with any suitable water heater appliance.

Turning now to FIG. 2, exemplary embodiments of water heater appliance 100 include an electric heating system, such as one or more of an upper heating element 118, a lower heating element 119, or a sealed system 120 in thermal communication with the tank 112. During operation of water heater appliance 100, one or all of upper heating element 118, lower heating element 119, or sealed system 120 may thus be selectively activated to heat water within interior volume 114 of tank 112.

As shown, the exemplary embodiments of FIG. 2 include upper heating element 118, lower heating element 119, or sealed system 120. Thus, the exemplary water heater appliance 100 is commonly referred to as a “heat pump water heater appliance.” Upper and lower heating elements 118 and 119 can be any suitable heating elements. For example, upper heating element 118 or lower heating element 119 may be an electric resistance element, a microwave element, an induction element, or any other suitable heating element (including combinations thereof). Lower heating element 119 may also be a gas burner. Moreover, it is understood that illustrated heat pump water heater appliance embodiments is merely a non-limiting example, and other water heater appliance configurations may be provided within the scope of the present disclosure (e.g., embodiments including more heating elements, fewer heating elements, no sealed system, or a relatively-small tank in which water is heated as it flows therethrough).

Sealed system 120 includes a compressor 122, a condenser 124, a throttling device 126, and an evaporator 128. Condenser 124 is thermally coupled or assembled in a heat exchange relationship with tank 112 in order to heat water within interior volume 114 of tank 112 during operation of sealed system 120. In particular, condenser 124 may be a conduit coiled around and mounted to tank 112. During operation of sealed system 120, refrigerant exits evaporator 128 as a fluid in the form of a superheated vapor or high quality vapor mixture. Upon exiting evaporator 128, the refrigerant enters compressor 122 wherein the pressure and temperature of the refrigerant are increased such that the refrigerant becomes a superheated vapor. The superheated vapor from compressor 122 enters condenser 124 wherein it transfers energy to the water within tank 112 and condenses into a saturated liquid or high quality liquid vapor mixture. This high quality/saturated liquid vapor mixture exits condenser 124 and travels through throttling device 126, which is configured for regulating a flow rate of refrigerant therethrough. Upon exiting throttling device 126, the pressure and temperature of the refrigerant drop at which time the refrigerant enters evaporator 128 and the cycle repeats itself. In certain exemplary embodiments, throttling device 126 may be an electronic expansion valve (EEV).

A fan or air handler 140 may assist with heat transfer between air about water heater appliance 100 (e.g., within casing 102) and refrigerant within evaporator 128. Air handler 140 may be positioned within casing 102 on or adjacent evaporator 128. Thus, when activated, air handler 140 may direct a flow of air towards or across evaporator 128, and the flow of air from air handler 140 may assist with heating refrigerant within evaporator 128. It is understood that air handler 140 may be any suitable type of air handler, such as an axial or centrifugal fan.

In certain embodiments, water heater appliance 100 includes a tank temperature sensor 130. Generally, tank temperature sensor 130 is configured for measuring a temperature of water within interior volume 114 of tank 112. Tank temperature sensor 130 can be positioned at any suitable location within or on water heater appliance 100. For example, tank temperature sensor 130 may be positioned within interior volume 114 of tank 112 or may be mounted to tank 112 outside of interior volume 114 of tank 112. When mounted to tank 112 outside of interior volume 114 of tank 112, tank temperature sensor 130 can be configured for indirectly measuring the temperature of water within interior volume 114 of tank 112. For example, tank temperature sensor 130 can measure the temperature of tank 112 and correlate the temperature of tank 112 to the temperature of water within interior volume 114 of tank 112. Tank temperature sensor 130 may also be positioned at or adjacent top portion 108 of water heater appliance 100 (e.g., at or adjacent an inlet of outlet conduit 106).

Tank temperature sensor 130 can be any suitable temperature sensor. For example, tank temperature sensor 130 may be a thermocouple or a thermistor. As may be seen in FIG. 2, in certain exemplary embodiments, tank temperature sensor 130 is the only temperature sensor positioned at or on tank 112 that is configured for measuring the temperature of water within interior volume 114 of tank 112. In alternative exemplary embodiments, however, additional temperature sensors are positioned at or on tank 112 to assist tank temperature sensor 130 with measuring the temperature of water within interior volume 114 of tank 112 (e.g., at other locations within interior volume 114 of tank 112).

In optional embodiments, water heater appliance 100 includes an ambient temperature sensor 132, an evaporator inlet temperature sensor 134, and an evaporator outlet temperature sensor 136. Ambient temperature sensor 132 is configured for measuring a temperature of air about water heater appliance 100. Ambient temperature sensor 132 can be positioned at any suitable location within or on water heater appliance 100. For example, ambient temperature sensor 132 may be mounted to casing 102 (e.g., at or adjacent top portion 108 of water heater appliance 100). Ambient temperature sensor 132 can be any suitable temperature sensor. For example, ambient temperature sensor 132 may be a thermocouple or a thermistor.

Evaporator inlet temperature sensor 134 is configured for measuring a temperature of refrigerant at or adjacent inlet of evaporator 128. Thus, evaporator inlet temperature sensor 134 may be positioned at or adjacent inlet of evaporator 128, as shown in FIG. 2. For example, evaporator inlet temperature sensor 134 may be mounted to tubing that directs refrigerant into evaporator 128 (e.g., at or adjacent inlet of evaporator 128). When mounted to tubing, evaporator inlet temperature sensor 134 can be configured for indirectly measuring the temperature of refrigerant at inlet of evaporator 128. For example, evaporator inlet temperature sensor 134 can measure the temperature of the tubing and correlate the temperature of the tubing to the temperature of refrigerant at inlet of evaporator 128. Evaporator inlet temperature sensor 134 can be any suitable temperature sensor. For example, evaporator inlet temperature sensor 134 may be a thermocouple or a thermistor.

Evaporator outlet temperature sensor 136 is configured for measuring a temperature of refrigerant at or adjacent outlet of evaporator 128. Thus, evaporator outlet temperature sensor 136 may be positioned at or adjacent outlet of evaporator 128, as shown in FIG. 2. For example, evaporator outlet temperature sensor 136 may be mounted to tubing that directs refrigerant out of evaporator 128 (e.g., at or adjacent outlet of evaporator 128). When mounted to tubing, evaporator outlet temperature sensor 136 can be configured for indirectly measuring the temperature of refrigerant at outlet of evaporator 128. For example, evaporator outlet temperature sensor 136 can measure the temperature of the tubing and correlate the temperature of the tubing to the temperature of refrigerant at outlet of evaporator 128. Evaporator outlet temperature sensor 136 can be any suitable temperature sensor. For example, evaporator outlet temperature sensor 136 may be a thermocouple or a thermistor.

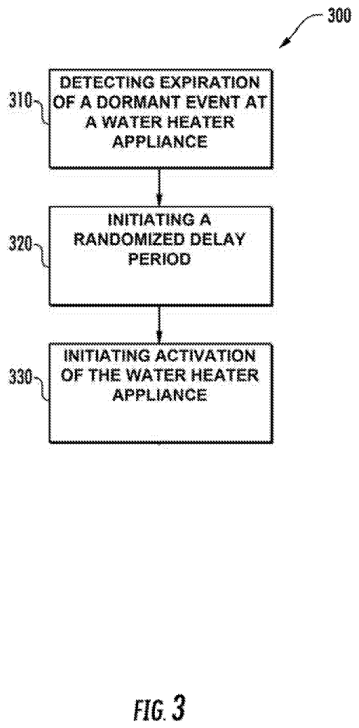

Water heater appliance 100 further includes a controller 150 that is configured for regulating operation of water heater appliance 100. In certain embodiments, controller 150 is in operative communication (e.g., direct electrical communication, indirect electrical communication, wireless communication, etc.) with one or more of upper heating element 118, lower heating element 119, compressor 122, tank temperature sensor 130, ambient temperature sensor 132, evaporator inlet temperature sensor 134, evaporator outlet temperature sensor 136, or air handler 140. When installed, controller 150 may further be in operative communication with a power source, such as a residential power grid through, for example, a utility meter 175. Thus, controller 150 may selectively activate and direct power to upper heating element 118, lower heating element, or compressor 122 in order to heat water within interior volume 114 of tank 112 (e.g., in response to signals from tank temperature sensor 130, ambient temperature sensor 132, evaporator inlet temperature sensor 134, or evaporator outlet temperature sensor 136). Moreover, controller 150 may initiate one or more heating cycles or methods (e.g., method 300—FIG. 3) to control operations of water heater appliance 100.

In some embodiments, controller 150 includes memory (e.g., non-transitive memory) and one or more processing devices (e.g., microprocessors, CPUs or the like), such as general or special purpose microprocessors operable to execute programming instructions or micro-control code associated with operation of water heater appliance 100. The memory can represent random access memory such as DRAM, or read only memory such as ROM or FLASH. The processor executes programming instructions stored in the memory. The memory can be a separate component from the processor or can be included onboard within the processor. Alternatively, controller 150 may be constructed without using a microprocessor (e.g., using a combination of discrete analog or digital logic circuitry; such as switches, amplifiers, integrators, comparators, flip-flops, AND gates, and the like) to perform control functionality instead of relying upon software.

In certain embodiments, controller 150 includes an analog-to-digital converter (ADC). Generally, the ADC may include any suitable circuit or architecture to convert an analog (e.g., voltage) signal into a digital signal (e.g., digital conversion value), as would be understood. One or more analog connection pins may be provided on the ADC such that one or more components (e.g., one or more temperature sensors) can electrically connect to controller 150 at the ADC (e.g., for the transmission of analog signals thereto). Moreover, one or more digital connection pins may be provided on the ADC such that the ADC can further connect to other portions of controller 150 (e.g., for the transmission of digital signals thereto).

In additional or alternative embodiments, a utility meter 175 is in operative (e.g., wired or wireless) communication with controller 150. For instance, utility meter 175 may be an advanced utility meter that measures utility usage and provides controller 150 with a demand response signal corresponding to electric power access including, for instance, real-time utility pricing, up-to-date utility costs, energy availability, etc., as would be understood. The utility meter 175 may be in one-way or two-way communication with the utility company to transmit a demand response signal to controller 150 based on information received or determined from signals received at the utility meter 175 from the utility company. Additionally or alternatively, utility meter 175 may be in one-way or two-way communication with a local power generator (e.g., solar power generator, wind power generator, etc.) to transmit a demand response signal to controller 150 based on information received or determined from signals received at the utility meter 175 from the local power generator.

Optionally, utility meter 175 may be programmed (e.g., by a user or installer at control panel 103) to communicate with the utility at a specific interval or utility meter 175 may be pre-programmed to automatically communicate with the utility or local power generator within a predetermined time interval. Thus, utility meter 175 may receive information regarding energy access (e.g., pricing, costs, availability, etc.) from the utility or local power generator before transmitting a demand response signal indicating energy consumption to the controller 150. Using, or in response to the demand response signal, the controller 150 may be configured to determine a restricted power condition exists (e.g., due to relatively high pricing per kWh or limited power availability). Additionally or alternatively, controller 150 may be programmed to include a demand schedule of anticipated/planned energy consumption (e.g., pricing, costs, availability, usage, etc.). Thus, controller 150 may reference (e.g., receive an internal demand response signal) the demand schedule to determine whether (i.e., if and when) a restricted power condition exists, such as a brownout or blackout (e.g., in the case of a utility), a Sabbath period (e.g., in the case of religiously-observant communities and appliance modes) a low-light state or a low-wind state (e.g., in the case of a local power generator), etc.

When activated, controller 150 may generally operate upper heating element 118, lower heating element 119, or compressor 122 in order to heat water within interior volume 114 of tank 112 (e.g., as part of a responsive-heating cycle). As an example, in certain modes of operation, a user may select or establish a set temperature, tₛ, for water within interior volume 114 of tank 112. Additionally or alternatively, the set temperature tₛ for water within interior volume 114 of tank 112 may be a default value. Based upon the set temperature tₛ for water within interior volume 114 of tank 112, controller 150 may selectively activate upper heating element 118, lower heating element 119, or compressor 122. For instance, a temperature range may be provided for the set temperature tₛ. In other words, a range may be provided that includes a set temperature minimum tₛₘᵢₙ and a set temperature maximum tₛₘᵢₙ, that is below and above, respectively, the set temperature tₛ. If the water within interior volume 114 of tank 112 falls below the set temperature minimum tₛₘᵢₙ, upper heating element 118, lower heating element 119, or compressor 122 may be activated to heat the water. If the water within interior volume 114 of tank 112 rises above the set temperature maximum tₛₘₐₓ, upper heating element 118, lower heating element 119, or compressor 122 may be deactivated to stop heating the water.

The set temperature is for water within interior volume 114 of tank 112 may be any suitable temperature. For example, the set temperature is for water within interior volume 114 of tank 112 may be a value between 90 and 150 degrees Fahrenheit (F) (32 to 65 degrees Celsius (C)). To prevent scalding and to save energy, consumers may set the thermostat to heat the reservoir water to a temperature in a range between 120 degrees F. to 140 degrees F. (about 49 degrees C. to 60 degrees C.).

As may be seen in FIG. 2, in some embodiments, water heater appliance 100 includes a mixing valve 200 and a mixed water outlet conduit 162. Generally, mixing valve 200 is in fluid communication with inlet conduit 104 via a bypass conduit 161, outlet conduit 106, and mixed water outlet conduit 162. In some such embodiments, mixing valve 200 is configured for selectively directing water from inlet conduit 104 and outlet conduit 106 into mixed water outlet conduit 162 in order to regulate a temperature of water within mixed water outlet conduit 162. Optionally, mixing valve 200 may be positioned or disposed within casing 102 of water heater appliance 100 (e.g., such that mixing valve 200 is integrated within water heater appliance 100).

In exemplary embodiments, mixing valve 200 can selectively adjust between a first position and a second position. In the first position, mixing valve 200 can permit a first flow rate of relatively cool water from inlet conduit 104 (shown schematically with arrow labeled F_{cool} in FIG. 2) into mixed water outlet conduit 162 and mixing valve 200 can also permit a first flow rate of relatively hot water from outlet conduit 106 (shown schematically with arrow labeled F_{heated} in FIG. 2) into mixed water outlet conduit 162. In such a manner, water within mixed water outlet conduit 162 (shown schematically with arrow labeled F_{mixed} in FIG. 2) can have a first particular temperature when mixing valve 200 is in the first position. Similarly, mixing valve 200 can permit a second flow rate of relatively cool water from inlet conduit 104 into mixed water outlet conduit 162 and mixing valve 200 can also permit a second flow rate of relatively hot water from outlet conduit 106 into mixed water outlet conduit 162 in the second position. The first and second flow rates of the relatively cool water and relatively hot water are different such that water within mixed water outlet conduit 162 can have a second particular temperature when mixing valve 200 is in the second position. In such a manner, mixing valve 200 can regulate the temperature of water within mixed water outlet conduit 162 and adjust the temperature of water within mixed water outlet conduit 162 between the first and second particular temperatures.

It should be understood that, in additional or alternative exemplary embodiments, mixing valve 200 is adjustable between more positions than the first and second positions. In particular, mixing valve 200 may be adjustable between any suitable number of positions in alternative exemplary embodiments. For example, mixing valve 200 may be infinitely adjustable in order to permit fine-tuning of the temperature of water within mixed water outlet conduit 162.

As shown, water heater appliance 100 may also include a position sensor 164. Position sensor 164 is configured for determining a position of mixing valve 200. Position sensor 164 can monitor the position of mixing valve 200 in order to assist with regulating the temperature of water within mixed water outlet conduit 162. For example, position sensor 164 can determine when mixing valve 200 is in the first position or the second position in order to ensure that mixing valve 200 is properly or suitably positioned depending upon the temperature of water within mixed water outlet conduit 162 desired or selected. Thus, position sensor 164 can provide feedback regarding the status or position of mixing valve 200.

Position sensor 164 may be any suitable type of sensor. For example, position sensor 164 may be a physical sensor, such as an optical sensor, Hall-effect sensor, etc. In alternative exemplary embodiments, water heater appliance 100 need not include position sensor 164, and controller 150 may determine or measure a motor position of mixing valve 200 based on a previously commanded position of mixing valve 200. Thus, controller 150 may determine that the current position of mixing valve 200 corresponds to a latest position that controller 150 commanded for mixing valve 200 in a previous iteration.

In certain embodiments, water heater appliance 100 also includes a mixed water conduit temperature sensor or first temperature sensor 170 and an inlet conduit temperature sensor or second temperature sensor 172. First temperature sensor 170 may be positioned on or proximate to mixed water outlet conduit 162 and is configured for measuring a temperature of water within mixed water outlet conduit 162. As shown, first temperature sensor 170 may also be positioned downstream of mixing valve 200. Second temperature sensor 172 is positioned on or proximate to inlet conduit 104 or bypass conduit 161 and is configured for measuring a temperature of water within inlet conduit 104 or bypass conduit 161. Second temperature sensor 172 may be positioned upstream of mixing valve 200. In certain exemplary embodiments, first temperature sensor 170 or second temperature sensor 172 may be positioned proximate or adjacent to mixing valve 200. First and second temperature sensors 170, 172 may be any suitable type of temperature sensors, such as a thermistor or thermocouple.

In some embodiments, controller 150 can also operate mixing valve 200 to regulate the temperature of water within mixed water outlet conduit 162. For instance, controller 150 can adjust the position of mixing valve 200 in order to regulate the temperature of water within mixed water outlet conduit 162. As an example, a user can select or establish a set-point temperature of mixing valve 200, or the set-point temperature of mixing valve 200 may be a default value. Based upon the set-point temperature of mixing valve 200, controller 150 can adjust the position of mixing valve 200 in order to set or adjust a ratio of relatively cool water flowing into mixed water outlet conduit 162 from inlet conduit 104 and relatively hot water flowing into mixed water outlet conduit 162 from outlet conduit 106. In such a manner, controller 150 can regulate the temperature of water within mixed water outlet conduit 162.

The set-point temperature of mixing valve 200 can be any suitable temperature. For example, the set-point temperature of mixing valve 200 may be a value between 90 and 150 degrees Fahrenheit (F) (32 to 65 degrees Celsius (C)). In particular, the set-point temperature of mixing valve 200 may be selected such that the set-point temperature of mixing valve 200 is less than the set-point temperature for water within interior volume 114 of tank 112. In such a manner, mixing valve 200 can utilize water from inlet conduit 104 and outlet conduit 106 to regulate the temperature of water within mixed water outlet conduit 162.

Advantageously, systems and methods within the present disclosure may prevent surges to a utility or residential power grid, such as might be caused by numerous water heater appliances suddenly drawing power from the grid at the same time.

Turning now to FIG. 3, a flow diagram is provided of a method 300 according to an exemplary embodiment of the present disclosure. Generally, the method 300 provides for controlling and operating a water heater appliance, such as water heater appliance 100 (FIG. 2) (e.g., according to a responsive-heating cycle). For instance, method 300 may provide for directing operations at one or more of control panel 103, upper heating element 118, lower heating element 119, compressor 122, mixing valve 200 (FIG. 2), as well as any other features of a suitable water appliance. The method 300 may be performed, for instance, by the controller 150. As described above, the controller 150 may be in operative communication with control panel 103, upper heating element 118, lower heating element 119, compressor 122, or mixing valve 200. Controller 150 may send signals to and receive signals from one or more of control panel 103, upper heating element 118, lower heating element 119, compressor 122, or mixing valve 200. Controller 150 may further be in communication with other suitable components of the appliance 100 to facilitate operation of the water heater appliance 100 generally.

Referring to FIG. 3, at 310, the method 300 includes detecting expiration of a dormant event at the water heater appliance. Generally, the dormant event is a planned or unplanned instance in which power to the water heater appliance is interrupted, halted, or otherwise restricted. For instance, the dormant event may be a power-loss event in which power to the water heater appliance is completely stopped. Detecting expiration of the dormant event may, thus, include receiving a power current or increased voltage (e.g., from 0 Volts), such as when the water heater appliance turns on or is otherwise activated. In additional or alternative embodiments, such as when the dormant event is planned or predicted, detecting expiration of the dormant event is in response to receiving a demand signal. Such a signal may be received, for instance, from a utility meter, a control panel of the water heater appliance, or an internal portion of the controller (e.g., as dictated by a programmed schedule). In some such embodiments, the demand signal is a restricted-use signal, such as might be received in anticipation or expiration of a planned brownout or ending of a Sabbath period for religiously-observant communities/appliances.

At 320, the method 300 includes initiating a randomized delay period in response to detecting expiration of the dormant event. During the delay period, the water heater appliance is held in an inactive or deactivated state. Thus, power to one or more portions of the water heater appliance may be prevented or otherwise restricted. For instance, the controller may prevent an electrical power current or voltage from being transmitted to the heating elements, compressor, mixing valve, or control panel.

In some embodiments, 320 includes calculating the delay period. In particular, the delay period may be calculated as a randomized fraction of a set maximum delay. In other words, the delay period (P) may be a function of the set maximum delay (M) as modified by a fraction of a randomizer variable (N) [e.g., P=M*(1/(1+N))]. Nonetheless, any suitable randomized function or steps may be provided for determining the delay period (P) (e.g., based on a randomizer variable). For instance, the randomizer variable may be selected as a value (e.g., between 0 and 9) of the lowest or least-significant bit of a digital conversion value read at a predetermined pin of the ADC (e.g., “5” in the four-bit digital conversion value “3065”) at the moment 320 starts. This value of the least-significant bit may generally correspond to electrical noise detected at the connection pin and will, thus, vary randomly.

In optional embodiments, delay period is less than or equal to five minutes. For instance, the set maximum delay may be programmed as five minutes. In additional or alternative embodiments, the set maximum delay may be less than two minutes. In further additional or alternative embodiments, a set minimum delay may be provided (e.g., greater than 10 seconds or 30 seconds). Thus, the delay period may be at least as long as the set minimum delay. Optionally, a set range may be provided for the delay period (e.g., 90 seconds). For instance, the set range may be established by the set minimum delay and the set maximum delay. Thus, the delay period may be calculated as a value from a function including both the set minimum delay and the set maximum delay.

At 330, the method 300 includes initiating activation of the water heater appliance following the delay period. Specifically, initiating activation may be in response to completion of 320 (i.e., determination of the expiration of the delay period). Thus, an electrical current or voltage may be prevented from being transmitted to the heating elements, compressor, mixing valve, or control panel (e.g., from the utility grid as directed by the controller). In some embodiments, 330 includes directing the water tank to an elevated temperature (e.g., above 32 degrees Celsius). As would be understood in light of the present disclosure, directing the water tank to the elevated temperature would require directing a current or voltage to the heating elements or compressor of the water heater appliance (e.g., to control operation, as described above). In additional or alternative embodiments, power is directed to other electrically-driven features of the water heater appliance (e.g., control panel).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a water heater appliance, the method comprising:
detecting expiration of a dormant event at the water heater appliance;
initiating a randomized delay period in response to detecting expiration of the dormant event; and
initiating activation of the water heater appliance following the randomized delay period.

2. The method of claim 1, wherein the dormant event comprises a power-loss event.

3. The method of claim 1, wherein detecting expiration of a dormant event comprises receiving a demand signal.

4. The method of claim 3, wherein the demand signal is a restricted-use signal.

5. The method of claim 1, wherein initiating the randomized delay period comprises calculating the randomized delay period as a randomized fraction of a set maximum delay.

6. The method of claim 1, wherein the randomized delay period is less than or equal to five minutes.

7. The method of claim 1, wherein initiating activation comprises directing a tank of the water heater appliance to an elevated temperature.

8. The method of claim 7, wherein the elevated temperature is above 32 degrees Celsius.

9. The method of claim 1, wherein initiating activation comprises directing power to a control panel.

10. A water heater appliance comprising a casing:
a tank disposed within the casing, the tank defining an inlet and an outlet;
an inlet conduit mounted to the tank at the inlet of the tank;
an electric heating system in thermal communication with the tank to heat water within the tank; and
a controller in operative communication with the electric heating system, the controller being configured to initiate a responsive-heating cycle, the responsive heating cycle comprising
detecting expiration of a dormant event at the water heater appliance,
initiating a randomized delay period in response to detecting expiration of the dormant event, and
initiating activation of the water heater appliance following the randomized delay period.

11. The water heater appliance 10, wherein the dormant event comprises a power-loss event.

12. The water heater appliance 10, wherein detecting expiration of a dormant event comprises receiving a demand signal.

13. The water heater appliance 12, wherein the demand signal is a restricted-use signal.

14. The water heater appliance 10, wherein initiating the randomized delay period comprises calculating the randomized delay period as a randomized fraction of a set maximum delay.

15. The water heater appliance 14, wherein the randomized delay period is less than or equal to five minutes.

16. The water heater appliance 10, wherein initiating activation comprises directing the tank of the water heater appliance to an elevated temperature.

17. The water heater appliance 16, wherein the elevated temperature is above 32 degrees Celsius.

18. The water heater appliance 10, further comprising a control panel mounted to the casing, wherein initiating activation comprises directing power to the control panel.
